(19) United States
(12) Patent Application Publication
(10) Pub. No.: US 2006/0124469 A1
(43) Pub. Date: Jun. 15, 2006

(54) Use of controlled atmosphere plasma spray combined with electrodeposition to fabricate a rocket engine chamber

(75) Inventors: Arnold W. Voigt, Bellevue, WA (US); Kimberly A. Wilson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Aerojet-General Corporation, Redmond, WA (US)

(21) Appl. No.: 11/259,946

(22) Filed: Oct. 26, 2005

Related U.S. Application Data
(60) Provisional application No. 60/622,515, filed on Oct. 26, 2004.

(51) Int. Cl. C25D 3/00; B05D 1/08

(52) U.S. Cl. 205/261; 427/446

(57) ABSTRACT

An electrodeposition process is used to manufacture a thin layer of iridium (212) on a mandrel. A Controlled Atmosphere Plasma Spray (CAPS) process is used to fabricate a rhenium, rhenium containing alloy, or refractory alloy layer (210) on the electrodeposited iridium layer (212). After deposition of rhenium, rhenium containing alloy, or refractory alloy, the process uses a second CAPS process to apply a transition refractory material (214, 216), such as niobium, at each end of a rocket engine chamber (200). The electrodeposited iridium layer (212) provides a highly purified, highly ductile, uniform iridium layer (212).

### CROSS-REFERENCE TO RELATED APPLICATION

This application claims the benefit of U.S. Provisional Application No. 60/622,515, filed Oct. 26, 2004, which is expressly incorporated herein by reference.

### FIELD OF THE INVENTION

The present invention is related to the manufacture of a rocket engine combustion chamber, and, in particular, to methods of forming the chamber by electrodeposition of an oxidation resistant material, followed by “controlled atmosphere” plasma spray deposition of a structural refractory material.

### BACKGROUND OF THE INVENTION

In order to withstand the demands experienced by a rocket engine, unique materials are employed in combination to meet the requirements of high temperature, high strength, and high ductility. Iridium has been applied to the interior of combustion chambers to withstand the high temperature and oxidizing environment. Rhenium, rhenium containing alloys, or other structural refractory metals or their alloys are used as the structural material of the combustion chamber because of their strength and ductility. Rhenium and rhenium containing alloys are not as brittle as iridium and can better withstand thermal cycling, but they are not rated to withstand the temperatures and oxidizing environments generated by rocket engine combustion gases. Accordingly, it has become customary to apply a layer of iridium on the inside of the combustion chamber and rhenium or a rhenium containing alloy on the exterior of the combustion chamber. However, the current state of the art for joining these dissimilar metals produces brittle, difficult to machine, costly parts.

### SUMMARY OF THE INVENTION

An electrodeposition process is used to manufacture a structure made from an oxidation resistant material, such as iridium. A Low Pressure Plasma Spray (LPPS) process or a Vacuum Plasma Spray (VPS) process, both collectively referred to in this application as a Controlled Atmosphere Plasma Spray process or CAPS, is used to deposit a structural refractory material, such as rhenium, rhenium containing alloys or other refractory metals and their alloys onto the oxidation resistant material. Electrodeposition of iridium may include an electrolyte that is either a molten salt or a chemical bath solution. After formation of an iridium layer by an electrodeposition process, a CAPS process may be utilized to deposit a structural refractory material. After deposition of the structural refractory material, the process uses a second CAPS process to deposit a transitional refractory material, such as niobium that is weldable to titanium alloys and/or columbium alloys. The process described may be used in the fabrication of rocket engine combustion chambers.

The electrodeposited iridium material provides a highly purified, highly ductile, uniform iridium layer as compared with other technologies, including Low Pressure Plasma Spray and Vacuum Plasma Spray. The use of electrodeposited iridium in combination with CAPS-deposited refractory structural materials offers reduced cycle times, less brittle, and more machineable material, and a cost reduction in the fabrication of rocket engine combustion chambers as compared to the state of the art. A rocket engine combustion chamber having a functionally graded transition between the structural refractory material and the transitional refractory material is also disclosed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a method in accordance with an embodiment of the invention;

FIG. 2 is an illustration of a combustion chamber for a rocket engine in accordance with an embodiment of the invention; and

FIG. 3 is a graphical illustration of a functionally graded structure in accordance with an embodiment of the invention.

### DETAILED DESCRIPTION OF THE PREFERRED EMBODIMENT

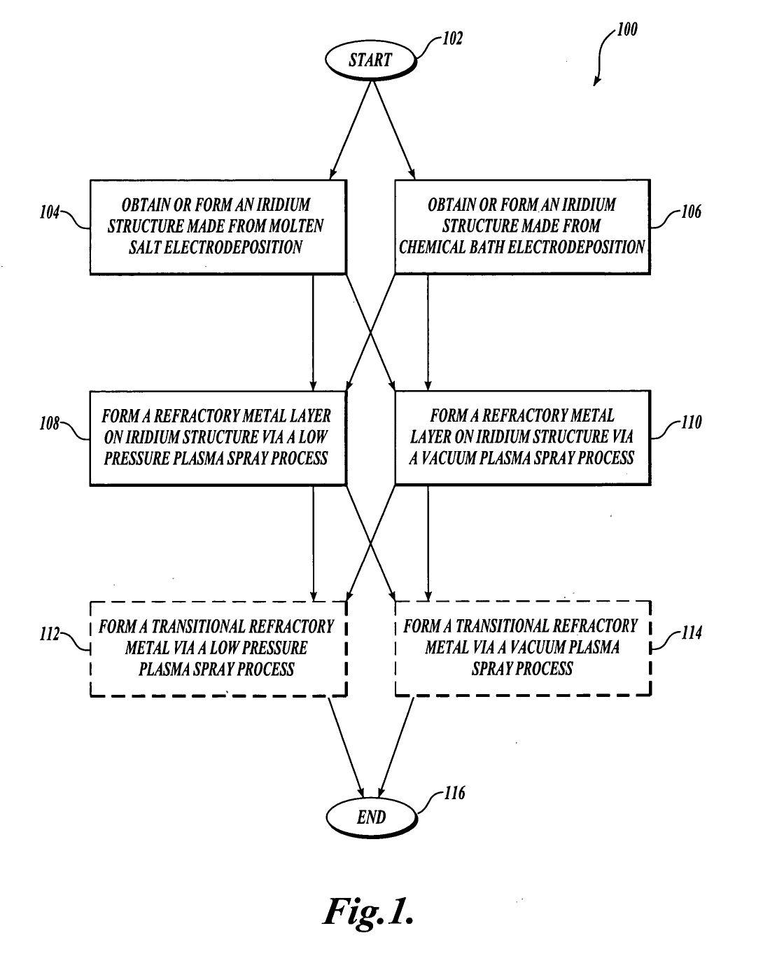

Referring to FIG. 1, a method 100 for the formation of a structure made from electrodeposition followed by CAPS deposition is illustrated. One embodiment of the invention includes an electrodeposition process to deposit an oxidation resistant layer, followed by a CAPS process to deposit a structural refractory layer on top of (or juxtaposed next to) the oxidation resistant layer. Block 102 indicates the start of the method 100. From block 102, the method 100 includes an electrodeposition process that may be carried out via the use of one of two different electrolytes. The electrodeposition process may include electrodeposition of the oxidation resistant layer from a molten salt, block 104, or from a chemical bath solution, block 106. The oxidation resistant material is typically iridium. Electrodeposition via either process of block 104 or block 106 results in the formation of an oxidation resistant layer. Following electrodeposition of the oxidation resistant material, from either block 104 or 106, the method 100 may enter either of blocks 108 or 110, indicating the option of the use of one of two different CAPS processes. A structural refractory material is applied via a CAPS process. The CAPS process may include a low pressure plasma spray process, block 108, or a vacuum plasma spray process, block 110. The structural refractory material may be rhenium, alloys of rhenium, molybdenum, alloys of molybdenum, tungsten, tantalum, or refractory metals and their alloys. The combination of an electrodeposition process of an oxidation resistant material and a CAPS deposition process of a structural refractory material may be used in the fabrication of rocket engine combustion chambers. The combination of an electrodeposition process with a CAPS process increases material ductility and reduces the overall cost previously required to fabricate rocket engine chambers.

Electrodeposition, blocks 104 and 106, includes applying an electric current to an electrolyte containing an ionic species of the oxidation resistant material to be deposited onto an electrode. A system for electrodeposition includes a vessel to contain the electrolyte, and a first and second electrode. One of the electrodes will serve as the substrate onto which the ionic species will be coated. A power source is in electrical contact with the first and the second electrode. As the power is increased, the cationic metal species in the electrolyte will deposit on the cathode electrode where reduction of the cationic metal species takes place. The cathode electrode may take the shape of the desired object, such as the interior of any one or all of a combustion chamber, throat, and nozzle of a rocket engine. The cathode electrode may be a “mandrel” to indicate that the layer that is deposited onto the cathode electrode will eventually be removed from the cathode electrode. In this case, the mandrel serves as a temporary support during the fabrication process. The electrolyte, as previously described, may include a molten salt or a chemical bath solution, each containing ionic species of the oxidation resistant material to be deposited. If the electrolyte is a molten salt, heating elements are provided on the electrolyte vessel to heat the salt to the salt's melting temperature to liberate the ions. If iridium is the oxidation resistant material to be deposited, the salt may be iridium oxide or iridium potassium cyanide. If a chemical bath solution is used as the electrolyte, the plating bath solution of iridium may include hydrobromic acid, and the iridium salt. If a molten salt is used as the electrolyte, the molten salt of iridium may include sodium or mixture of sodium cyanide and potassium cyanide. The temperature and current density are variables to be adjusted to achieve the optimum deposition performance. Metal, such as iridium, is deposited on a mandrel of the specific shape of interest and processing is controlled to obtain the desired thickness and purity. A thin layer of iridium is applied to a mandrel as the protective coating for the structural refractory layer against oxidation.

The result of the electrodeposition process is a structure having an oxidation resistant layer. To this structure is added a structural refractory metal using a controlled atmosphere plasma spray process. From either of blocks 104 or 106, the method 100 may enter either of blocks 108 or 110. The controlled atmosphere plasma spray process may include a vacuum plasma spray process, block 108, or a low pressure plasma spray process, block 110. Both controlled atmosphere spray processes include plasma spraying. In plasma spraying, a stream of ionized inert plasma gas is generated with an electric arc. The structural refractory material is provided to the plasma stream as a powder which is carried by and melted by the plasma stream. The plasma stream is directed at the structure having the oxidation resistant material. The plasma stream impinges on the structure having the oxidation resistant material, thereby coating the oxidation resistant layer with a structural refractory metal layer. Plasma spraying is carried out at low pressures, typically less than one psia to about 6.0 psia. However, plasma spraying may be carried out at pressures from 0 psia to 14.7 psia. After completion of one of the two controlled atmosphere plasma spray processes, block 108 or 110, a structure having a structural refractory material on top of (or juxtaposed next to) an oxidation resistant material is provided.

From either block 108 or 110, the method 100 may proceed to either of blocks 112 or 114, wherein a further controlled atmosphere plasma spray process may be performed to add a transitional refractory metal on top of (or juxtaposed next to) the structural refractory metal. Such transitional refractory metal may include niobium (columbium). The transitional refractory material may be required in some instances. For example, in rocket engines, fuel injectors are usually made from titanium or titanium alloys which are difficult to weld to the structural refractory materials, such as rhenium. This problem is solved by applying a transitional refractory material to the structural refractory material, which can be welded to titanium or titanium alloys. The transitional refractory material includes niobium (columbium). The controlled atmosphere plasma spray process to deposit a transitional refractory material may include a low pressure plasma spray process, block 112, or a vacuum plasma spray process, block 114. Blocks 112 and 114 are drawn in broken line to signify blocks 112 and 114 are optional. If either of blocks 112 or 114 is used, the method 100 terminates in block 116 from either block 112 or 114. If absent, method 100 may terminate from either of blocks 108 or 110. It is to be understood that FIG. 1 does not show intermediary or finishing steps for clarity and brevity.

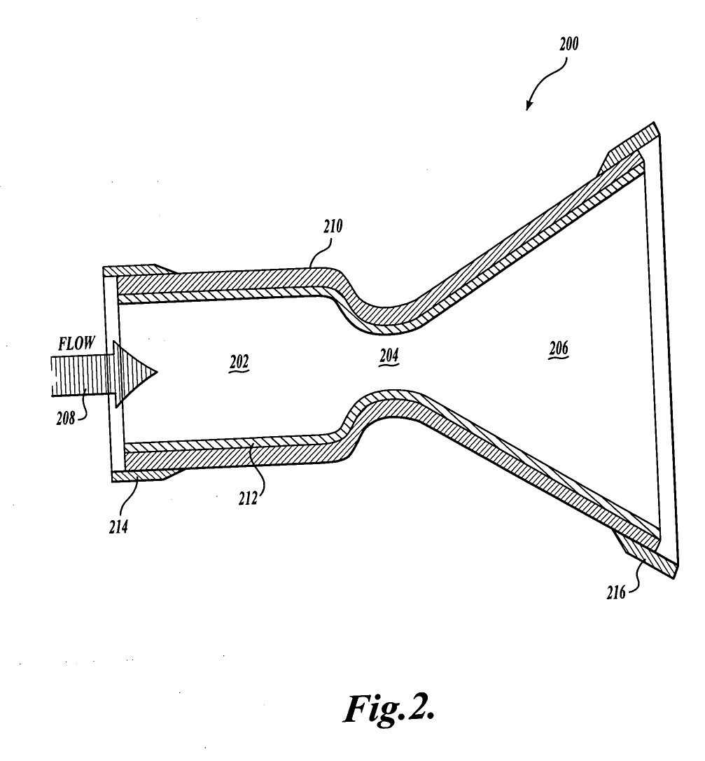

Referring to FIG. 2, one embodiment of a structure 200 made in accordance with the method 100 is illustrated. The structure 200 is a rocket engine combustion chamber. The structure 200 includes a combustion chamber 202 connected to the throat 204, which is connected to the expansion nozzle 206. The arrow 208 illustrates the flow of propellant from an injector (not shown). The combustion chamber 202 is for combustion of the propellants into combustion products. The throat 204 is for acceleration of the combustion products to a sonic condition. The expansion nozzle 206 is for acceleration of the combustion products to supersonic speeds. Each of the components 202, 204, and 206, has an oxidation resistant material 212 on the interior, and a structural refractory material 210 on the exterior. A transitional refractory material 214, and 216, is formed on the inlet end of the combustion chamber 202 and on the outlet end of the nozzle 206. The oxidation resistant material 212 is formed using an electrodeposition process that may include an electrolyte being a molten salt or a chemical bath solution. The structural refractory material 210 is formed using a controlled atmosphere plasma spray process that may include a vacuum plasma spray process or a low pressure plasma spray process. The transitional refractory material 214, and 216, is formed using a controlled atmosphere plasma spray process that may include a vacuum plasma spray process or a low pressure plasma spray process.

An electrodeposited iridium layer 212 protects the structural refractory layer 210 from oxidation. Rhenium, rhenium containing alloys, molybdenum, molybdenum containing alloys, tungsten, alloys containing tungsten, tantalum, alloys containing tantalum, or other refractory metals and their alloys are the materials used for the structural refractory layer 210. Niobium or tantalum is used for the transition structures 214, and 216, from refractory material 210 to titanium injector or nozzle (C-103 columbium alloy). The iridium layer thickness is typically 0.002 to 0.010 inches, the rhenium layer thickness is typically 0.040 to 0.250 inches, and the niobium layer thickness is typically 0.070 to 0.120 inches.

The structural refractory layer 210 is subject to rapid oxidation when in the presence of the products of combustion. To prevent deterioration, the thin layer of iridium 212 will protect the structural refractory layer 210 from oxidation. The electrodeposited iridium layer 212 may be greater than 99.9% pure and is highly ductile. The chamber 202 is joined by fusion welding to the injector (not shown) at the upstream end at the transitional refractory material 214 and to the nozzle (not shown) at the downstream end at the transitional refractory material 216. Rhenium is not directly weldable to the materials of construction for either the injector (titanium alloy) or the nozzle (columbium alloy). In order to join the chamber 200 to the injector (not shown) and the chamber 200 to the nozzle (not shown), niobium (i.e., columbium) is deposited on both the upstream and downstream ends of the chamber 200. A sufficient thickness of niobium is deposited onto the previously deposited structural refractory layer 212 where the niobium is allowed to overhang the structural refractory layer 210. The niobium is then machined to an appropriate weld joint configuration to permit fusion weld attachment of both the injector and nozzle.

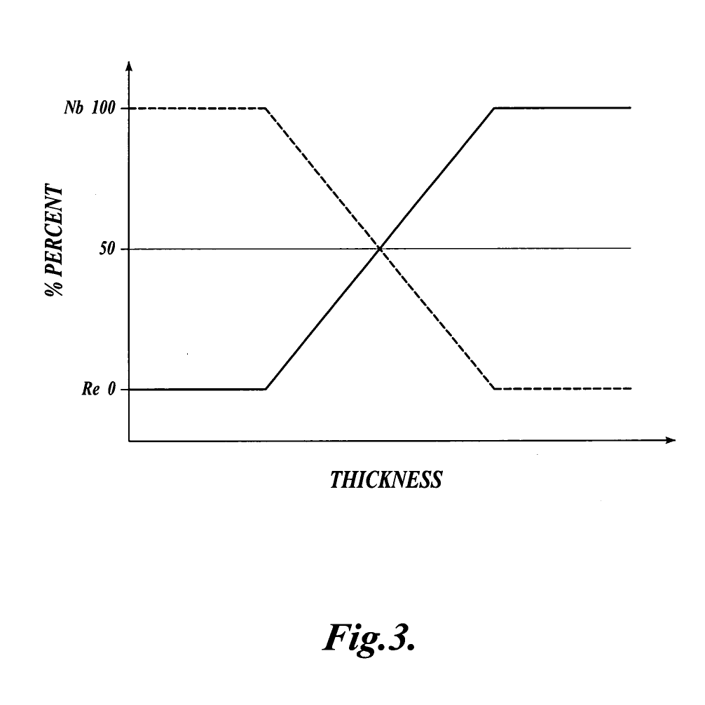

In one embodiment, the transitional refractory material 214, and 216, is “functionally graded” onto the structural refractory material layer 210. Functionally graded as applied to two dissimilar materials means that the percentage of the interior material decreases in the direction toward the exterior, while the percentage of the exterior material decreases in the direction toward the interior. For example, if niobium is applied to a rhenium structure, wherein the rhenium is the interior material and niobium is the exterior material, the rhenium material would constitute 100% and the niobium material would constitute 0% at some point along the cross section of the structure. However, moving outward from that point, the rhenium material gradually decreases in composition, while the niobium material increases in composition. At the exterior surface, the rhenium material constitutes 0%, while the niobium material now constitutes 100%. However, 100% niobium may extend a short distance from the exterior toward the interior, before a functionally graded structure is present. Similarly, the rhenium may extend a short distance from the interior toward the exterior, before a functionally graded structure is present. In FIG. 3, for example, niobium and rhenium is plotted against the thickness of a representative functionally graded structure. At the exterior side of the structure, the composition is 100% niobium and 0% rhenium. At a distance measured from the exterior, the percentage of niobium decreases, while the percentage of rhenium increases. At a distance measured from the exterior, rhenium is 100% and niobium is 0%, and continues at these percentages for the remainder of the structure. Applying a functionally graded material onto a rocket engine chamber is advantageous because the thermal coefficient of expansion is reduced compared to a rocket engine chamber with a sharp transition between metals.

An embodiment of the invention produces a chamber system with the advantages of ductility and a lower mass without significant reduction in the maximum operating temperature as compared to the state of the art.

While the preferred embodiment of the invention has been illustrated and described, it will be appreciated that various changes can be made therein without departing from the spirit and scope of the invention.

The embodiments of the invention in which an exclusive property or privilege is: claimed are defined as follows:

1. A method, comprising:
forming an oxidation resistant material from an electrodeposition process, and
forming a structural refractory material on the oxidation resistant material from a controlled atmosphere plasma spray process.

2. The method of claim 1, wherein the electrodeposition process includes depositing the oxidation resistant material from a molten salt electrolyte.

3. The method of claim 1, wherein the electrodeposition process includes depositing the oxidation resistant material from a chemical bath solution electrolyte.

4. The method of claim 1, wherein the controlled atmosphere plasma spray process includes depositing the structural refractory material at pressures from 0 to 14:7 psia.

5. The method of claim 1, further comprising forming a transitional refractory material on the structural refractory material.

6. The method of claim 5, wherein the transitional refractory material comprises niobium or tantalum.

7. The method of claim 1, wherein the oxidation resistant material comprises iridium.

8. The method of claim 1, wherein the structural refractory material is at least one of rhenium, molybdenum, alloys of rhenium, alloys of molybdenum, tungsten, alloys of tungsten, tantalum, alloys of tantalum or combinations thereof.

9. A method for manufacturing a combustion chamber, comprising:
forming an oxidation resistant material from an electrodeposition process, and
forming a structural refractory material on the oxidation resistant material from a controlled atmosphere plasma spray process, wherein the oxidation resistant material and the structural refractory material are deposited in a shape representative of the combustion chamber.

10. The method of claim 9, wherein the electrodeposition process includes depositing the oxidation resistant material from a molten salt electrolyte.

11. The method of claim 9, wherein the electrodeposition process includes depositing the oxidation resistant material from a chemical bath solution electrolyte.

12. The method of claim 9, wherein the controlled atmosphere plasma spray process includes depositing the structural refractory material at a pressure from 0 to 14.7 psia.

13. The method of claim 9, further comprising forming a transitional refractory material on the structural refractory material.

14. The method of claim 13, wherein the transitional refractory material comprises niobium or tantalum.

15. The method of claim 9, wherein the oxidation resistant material comprises iridium.

16. The method of claim 9, wherein the structural refractory material is at least one of rhenium, molybdenum, alloys of rhenium, alloys of molybdenum, tungsten, alloys of tungsten, tantalum, alloys of tantalum, or combinations thereof.

17. A method for making a combustion chamber, comprising:
obtaining a layer comprising an oxidation resistant material deposited via an electrodeposition process;
forming a structural refractory material on the oxidation resistant material from a controlled atmosphere plasma spray process,
wherein the oxidation resistant material and the structural refractory material are deposited in a shape representative of the combustion chamber.

18. The method of claim 17, wherein the electrodeposition process includes depositing the oxidation resistant material from a molten salt electrolyte.

19. The method of claim 17, wherein the electrodeposition process includes depositing the oxidation resistant material from a chemical bath solution electrolyte.

20. A method for attaching a material comprising titanium to a structural refractory material comprising rhenium, the method comprising, applying a transitional refractory material comprising niobium or tantalum, and a structural refractory material comprising rhenium in a functionally graded manner onto the structural refractory material comprising rhenium.
